(19) United States
(12) Patent Application Publication
(10) Pub. No.: US 2010/0290259 A1
(43) Pub. Date: Nov. 18, 2010

(54) VOLTAGE STABILIZING MODULE FOR BICYCLE GENERATOR

(76) Inventors: Su-Chang Liao, Taichung-city (TW); Di-Shun Liao, Taichung-city (TW)

Correspondence Address: Chien-Hui Su, P. O. Box 70-121 Taichung, Taichung City, 40899, TW

(21) Appl. No.: 12/467,308

(22) Filed: May 18, 2009

(51) Int. Cl. H02M 7/12

(52) U.S. Cl. 363/74

(57) ABSTRACT

A voltage stabilizing module for bicycle generator includes a voltage input, a rectifier circuit electrically connected to the voltage input, a detective switch electrically connected to the rectifier circuit, a stabilizing integrated circuit selectively electrically connected to the detective switch, a filter circuit electrically connected to the stabilizing integrated circuit, and a voltage output electrically connected to the filter circuit.

### BACKGROUND OF THE INVENTION

1. Field of the Invention

The present invention relates to a stabilizing module, and more particularly to a voltage stabilizing module for a bicycle generator.

2. Description of Related Art

A conventional generator is installed in a hub of a bicycle to generate electricity. The generator in the hub transforms a physical strength of riding the bicycle to the electricity for providing a lamp of the bicycle.

However, an electrical intensity of the conventional generator is relied on a rotative speed of the hub and is unstable due to the rotative speed of the hub. When the riding speed of the bicycle is picked up, a light of the lamp is increased. On the contrary, when the riding speed of the bicycle is slow downed, the light of the lamp is decreased. Furthermore, the voltage is increased when the rotative speed of the hub is picked up. When the bicycle is rode in a high speed, the voltage is high such that the lamp is easily overloaded and burned.

The present invention has arisen to mitigate and/or obviate the disadvantages of the conventional generator.

### SUMMARY OF THE INVENTION

The main objective of the present invention is to provide an improved voltage stabilizing module for bicycle generator.

To achieve the objective, a voltage stabilizing module for bicycle generator in accordance with the present invention comprises a voltage input, a rectifier circuit electrically connected to the voltage input, a detective switch electrically connected to the rectifier circuit, a stabilizing integrated circuit selectively electrically connected to the detective switch, a filter circuit electrically connected to the stabilizing integrated circuit, and a voltage output electrically connected to the filter circuit. The voltage input is provided for connecting to a bicycle generator hub. The rectifier circuit is provided for converting a variable frequency alternating current generated to a direct current. The rectifier circuit is a bridge rectifier circuit. The detective switch detects a voltage value of the direct current and compares with a preset voltage value. The stabilizing integrated circuit is a pulse-width modulation Buck DC/DC converter. The stabilizing integrated circuit is provided for tuning and diminishing the direct current converted by the rectifier circuit. The filter circuit is a L-C filter circuit. The filter circuit is provided for eliminating a ripple current in the direct current. The voltage output is provided for adapting to connect to an electronic device. A base is provided for connecting the voltage stabilizing module. The base includes a seat formed thereon and a loading member mounted on a bottom of the seat. The seat is provided for adapting to connect to the electronic device. The voltage stabilizing module is connected to the seat. The loading member is provided for lockably fixing the base on the bicycle.

Further benefits and advantages of the present invention will become apparent after a careful reading of the detailed description with appropriate reference to the accompanying drawings.

### BRIEF DESCRIPTION OF THE DRAWINGS

FIG. 1 is a circuit diagram of a voltage stabilizing module for bicycle generator in accordance with the present invention;

FIG. 2 is a flow chart of the voltage stabilizing module for bicycle generator in accordance with the present invention; and

FIGS. 3-5 are perspective views of a base connected to the voltage stabilizing module in accordance with the present invention.

### DETAILED DESCRIPTION OF THE INVENTION

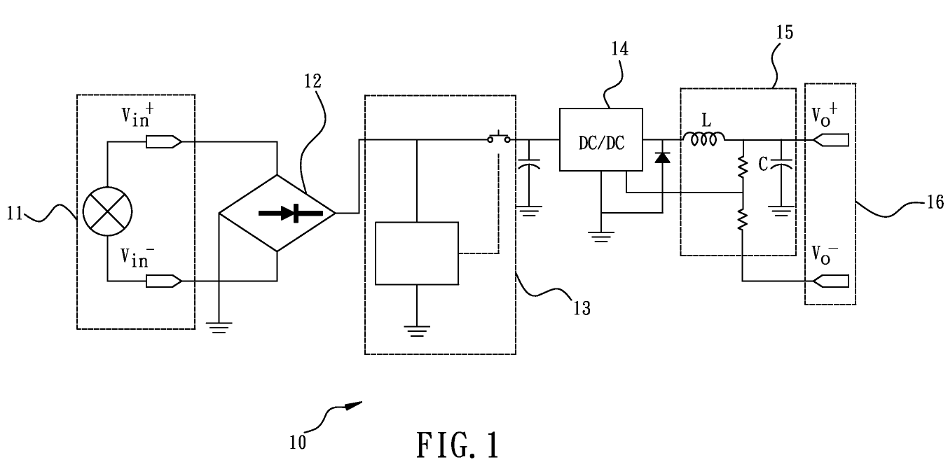

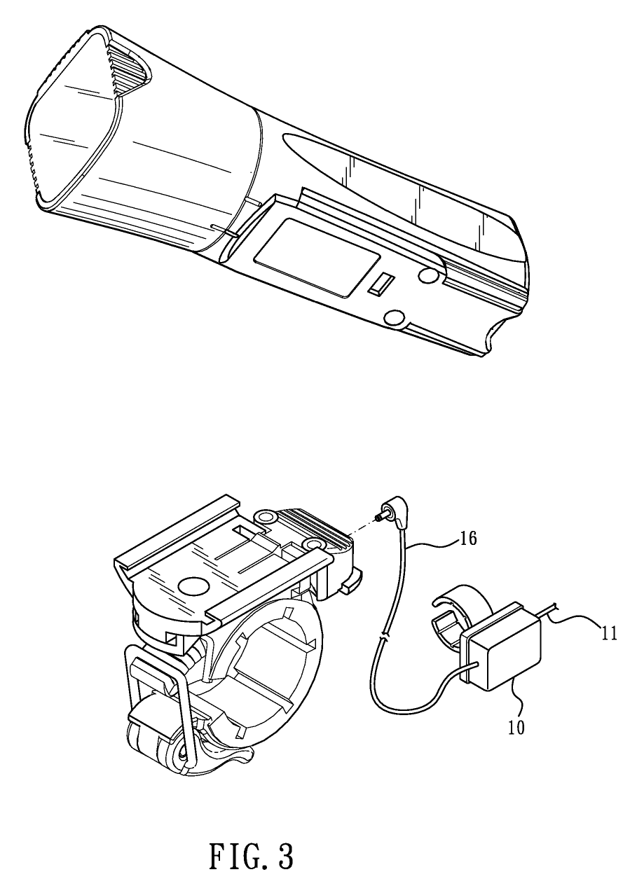

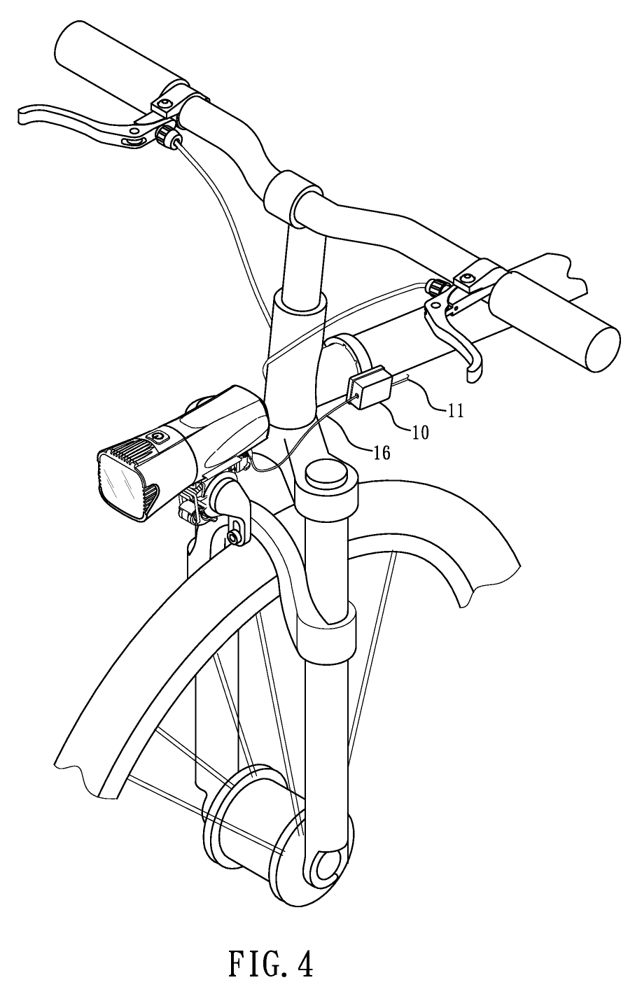

Referring to the drawings and initially to FIGS. 1-5, a voltage stabilizing module (10) for bicycle generator in accordance with the present invention comprises a voltage input (11), a rectifier circuit (12) electrically connected to the voltage input (11), a detective switch (13) electrically connected to the rectifier circuit (12), a stabilizing integrated circuit (14) selectively electrically connected to the detective switch (13), a filter circuit (15) electrically connected to the stabilizing integrated circuit (14), and a voltage output (16) electrically connected to the filter circuit (15).

The voltage input (11) is provided for connecting to a bicycle generator hub (not numbered). The bicycle generator hub is a conventional apparatus. The detail of the bicycle generator hub would not be described in the present invention. When a bicycle is rode moving and the bicycle generator hub is rotated, an electricity power is generated by the bicycle generator. The electricity power generated by the bicycle generator is a variable frequency alternating current. The rectifier circuit (12) is provided for converting the variable frequency alternating current generated to a direct current. The rectifier circuit (12) is a bridge rectifier circuit (12). The detective switch (13) detects a voltage value of the direct current and compares with a preset voltage value. When the voltage value of the direct current is higher than the preset voltage value, the detective switch (13) electrically disconnects to the stabilizing integrated circuit (14) for preventing the stabilizing integrated circuit (14) from overloading and burning. When the voltage value of the direct current is lower or equal to the preset voltage value, the detective switch (13) electrically connects to the stabilizing integrated circuit (14) for providing a stable voltage current. The stabilizing integrated circuit (14) is a pulse-width modulation Buck DC/DC converter. The stabilizing integrated circuit (14) is provided for tuning and diminishing the direct current converted by the rectifier circuit (12) to a direct current with a stable voltage value. The filter circuit (15) is a L-C filter circuit (15). The L-C filter circuit (15) is comprised of an inductor (L) and a capacitor (C). The filter circuit (15) is provided for eliminating a ripple current in the direct current. The filter circuit (15) filters off the ripple current from the direct current such that the direct current has a clear stable voltage. The voltage output (16) is provided for adapting to connect to an electronic device, such as a lamp, a music player, a Global Positioning System, and a speedometer.

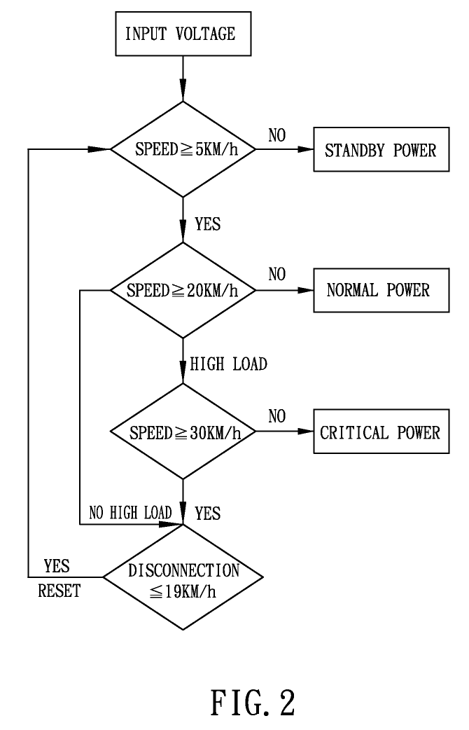

With reference to FIG. 2, that shows a flow chart of the voltage stabilizing module (10) of present invention applied in the bicycle generator hub for showing a procedure of the voltage stabilizing module (10). When a speed of the bicycle is lower than 5 kilometers/hour, the detective switch (13) detects the direct current converted by the rectifier circuit (12) and is electrically disconnected due to the electricity power generated by the bicycle generator hub is a standby power and not enough to trigger the stabilizing integrated circuit (14). When the speed of the bicycle is between 5 and 20 kilometers/hour and the electricity power generated by the bicycle generator hub is a normal power, the detective switch (13) detects the direct current converted by the rectifier circuit (12) and is electrically connected to the stabilizing integrated circuit (14) for providing a direct current with a stable voltage. When the speed of the bicycle is high than 19 kilometers/hour, the detective switch (13) detects the direct current converted by the rectifier circuit (12) and is electrically disconnected to the stabilizing integrated circuit (14) due to the voltage value of the direct current is higher than a voltage value endured by the stabilizing integrated circuit (14) for preventing the stabilizing integrated circuit (14) from burning. When the speed of the bicycle is down and between 5 and 20 kilometers/hour, the detective switch (13) detects the direct current converted by the rectifier circuit (12) and is electrically connected to the stabilizing integrated circuit (14). When the voltage output (16) is connected to an electronic device needing a high load current, the direct current provided by the detective switch (13) is higher. In the preferred embodiment of the present invention, the speed of the bicycle is 30 kilometers/hour and the electricity power generated by the bicycle generator hub is a critical power. The voltage value detected by the detective switch (13) is higher than that of the critical power such that the detective switch (13) is disconnected to the stabilizing integrated circuit (14).

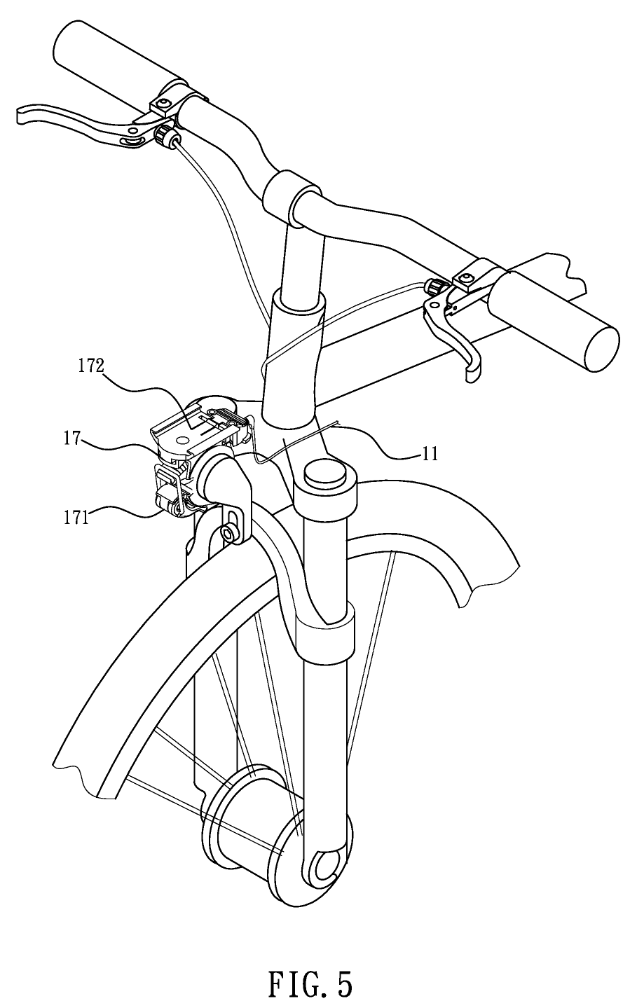

With reference to FIG. 5, that shows a base (17) provided for loading the voltage stabilizing module (10). The base (17) includes a seat (172) formed thereon and a loading member (171) mounted on a bottom of the seat (172). The base (17) is provided for connecting to the electronic device. The voltage stabilizing module (10) is connected to the seat (172) such that the voltage stabilizing module (10) is connected to the electronic device via the seat (172). The loading member (171) is a C-shaped ring and provided for lockably fixing the base (17) on the bicycle.

Although the invention has been explained in relation to its preferred embodiment, it is to be understood that many other possible modifications and variations can be made without departing from the spirit and scope of the invention as hereinafter claimed.

What is claimed is:

1. A voltage stabilizing module for bicycle generator comprising:
a voltage input provided for adapting to connect to a bicycle generator hub;
a rectifier circuit electrically connected to the voltage input, the rectifier circuit provided for converting a variable frequency alternating current generated by the bicycle generator to a direct current;
a detective switch electrically connected to the rectifier circuit, the detective switch detecting a voltage value of the direct current and comparing with a preset voltage value for providing a selective connection;
a stabilizing integrated circuit selectively electrically connected to the detective switch, the stabilizing integrated circuit provided for tuning and diminishing the direct current to a direct current having a stable voltage value;
a filter circuit electrically connected to the stabilizing integrated circuit, the filter circuit provided for eliminating a ripple current in the direct current; and
a voltage output electrically connected to filter circuit, the voltage output provided for adapting to connect to an electronic device;
wherein when the bicycle generator hub generates a current having a voltage value higher than the preset voltage value, the detective switch detects the voltage value and disconnects to the stabilizing integrated circuit for preventing the stabilizing integrated circuit from burning; when the bicycle generator hub generates a current having a voltage value equal/lower than the preset voltage value, the detective switch detects the voltage value and connects to the stabilizing integrated circuit for providing a current having a stable voltage value.

2. The voltage stabilizing module for bicycle generator as claimed in claim 1, wherein the stabilizing integrated circuit is a pulse-width modulation Buck DC/DC converter.

3. The voltage stabilizing module for bicycle generator as claimed in claim 1, wherein the rectifier circuit is a bridge rectifier circuit.

4. The voltage stabilizing module for bicycle generator as claimed in claim 1, wherein the filter circuit is a L-C filter circuit.

5. A voltage stabilizing module for bicycle generator comprising:
a voltage input provided for adapting to connect to a bicycle generator hub;
a rectifier circuit electrically connected to the voltage input, the rectifier circuit provided for converting a variable frequency alternating current generated by the bicycle generator to a direct current;
a detective switch electrically connected to the rectifier circuit, the detective switch detecting a voltage value of the direct current and comparing with a preset voltage value for providing a selective connection;
a stabilizing integrated circuit selectively electrically connected to the detective switch, the stabilizing integrated circuit provided for tuning and diminishing the direct current to a direct current having a stable voltage value;
a filter circuit electrically connected to the stabilizing integrated circuit, the filter circuit provided for eliminating a ripple current in the direct current;
a voltage output electrically connected to filter circuit, the voltage output provided for adapting to connect to an electronic device; and
a base provided for connecting the voltage stabilizing module, the base including a seat formed thereon and a loading member mounted on a bottom of the seat, the seat provided for adapting to connect to the electronic device, the voltage stabilizing module connected to the seat, the loading member provided for lockably fixing the base on the bicycle;
wherein when the bicycle generator hub generates a current having a voltage value higher than the preset voltage value, the detective switch detects the voltage value and disconnects to the stabilizing integrated circuit for preventing the stabilizing integrated circuit from burning; when the bicycle generator hub generates a current having a voltage value equal/lower than the preset voltage value, the detective switch detects the voltage value and connects to the stabilizing integrated circuit for providing a current having a stable voltage value.

6. The voltage stabilizing module for bicycle generator as claimed in claim 1, wherein the stabilizing integrated circuit is a pulse-width modulation Buck DC/DC converter.

7. The voltage stabilizing module for bicycle generator as claimed in claim 1, wherein the rectifier circuit is a bridge rectifier circuit.

8. The voltage stabilizing module for bicycle generator as claimed in claim 1, wherein the filter circuit is a L-C filter circuit.
